(19) United States
(12) Patent Application Publication
(10) Pub. No.: US 2022/0154457 A1
(43) Pub. Date: May 19, 2022

(54) MOUNTING SYSTEM FOR AN ACOUSTIC BAFFLE SYSTEM

(71) Applicant: Instyle Contract Textiles Pty Ltd, Mascot (AU)

(72) Inventor: Philip Adams, Mascot (AU)

(21) Appl. No.: 17/097,474

(22) Filed: Nov. 13, 2020

(51) Int. Cl. E04B 1/99; G10K 11/162

(52) U.S. Cl. CPC E04B 1/99; G10K 11/162

(57) ABSTRACT

A retaining assembly includes a clamping member for holding a cross member to an acoustic panel so that the cross member extends orthogonally to a longitudinal axis of the acoustic panel. The clamping member is configured to locate the cross member against the acoustic panel and includes at least one aperture for receiving a securing member to secure the clamping member to the acoustic panel. A mounting system is also provided, having the retaining assembly, one or more of the cross members and a plurality of connecting elements for connecting the cross members to the acoustic panel. An acoustic baffle system is further provided including a plurality of the acoustic panels and a plurality of stiffening members configured for attachment to a respective acoustic panel. The mounting system is used to connect the stiffening members to the acoustic panels.

### BACKGROUND

### Technical Field

This disclosure relates to acoustic baffle systems, and in particular to a support system and related mounting components for supporting panels of an acoustic baffle system to a wall, ceiling or other base structure.

### Description of the Related Art

Any discussion of prior devices and systems throughout the specification should in no way be considered as an admission that such is widely known or forms part of common general knowledge in the field.

Ceiling-mounted baffle system can be used to improve or control the acoustic characteristics of relatively large open areas, rooms or spaces within a building. In some uses, such baffle systems can also provide desired visual aesthetics such as patterned or screening effects. However, the versatility of many existing baffle systems is often constrained by the associated mounting hardware, which limits the manner, orientation and location in which a baffle system is mounted in practice. Given the flexibility of these baffle systems in terms of their ability to provide both acoustic and aesthetic functionality, there is a need for mounting hardware which can accommodate different methods of installation.

### BRIEF SUMMARY

According to a first aspect of the present disclosure, there is provided a mounting system for an acoustic panel, including:
one or more cross members for supporting the acoustic panel, and
a plurality of connecting elements for connecting the one of more cross members to at least one panel such that the one or more cross members extend orthogonally to the longitudinal axis of the at least one panel.

In some embodiments, the connecting elements include a mounting element for engaging the panel and a retaining assembly for retaining the cross member to the mounting element.

In some embodiments, the mounting element includes one or more apertures for receiving a fastener to connect the mounting element to the panel. In one embodiment, the mounting element includes a planar element. In one preferred embodiment, the mounting element includes a plate. Any suitable fastener, including a nail, bolt or screw, may be used to fasten the mounting element to the acoustic panel. Where the acoustic panel includes a stiffening member, the mounting element is preferably fastened to the stiffening member.

In some embodiments, the retaining assembly includes a clamping member for holding the cross member so that the cross member extends orthogonally to the longitudinal axis the at least one panel and a securing member for securing the clamping member to the cross member. In other embodiments, the clamping member holds the cross member against the mounting element. In further embodiments, the securing member engages the clamping member to hold the cross member.

In some embodiments, the clamping member includes an opening to receive the cross member. In one embodiment, the opening includes a slot to receive the cross member. Preferably, the slot is an open slot. In a preferred embodiment, the opening or slot is arranged to be orthogonal to the longitudinal axis of the at least one panel when the connecting elements are connected to the at least one panel.

In some embodiments, the clamping member includes a shaft. The securing member preferably engages the shaft or bolt to secure the cross member to the clamping member. In one preferred embodiment, the clamping member includes a bolt having the opening or slot. In another embodiment, the clamping member includes a threaded bolt with the opening or slot. The securing member in this embodiment includes a nut having a threaded internal bore to engage the threaded bolt and secure the cross member to the clamping member.

In some embodiments, the clamping member is configured to locate the cross member so that the cross member extends orthogonally to the longitudinal axis of the at least one panel. In other embodiments, the clamping member is configured to engage or grip a portion of the cross member. In further embodiments, the clamping member is configured to at least partially wrap around the cross member. In yet other embodiments, the clamping member has a shape at least partly complementary to the shape of the cross member. In yet further embodiments, the clamping member includes a planar element. In yet another embodiment, the clamping member has a triangular shape.

In some embodiments, the clamping member includes one or more apertures for receiving one or more securing members. Each securing member may include a shaft and a fastener for engaging the shaft. In other embodiments, the securing member includes a threaded bolt and the fastener includes a nut for engaging the threaded bolt.

In some embodiments, at least one securing member is connected to the mounting element. In other embodiments, the at least one securing member is fixed or integrally formed with the mounting element. In further embodiments, the at least one securing member is removably connected to the mounting element. In one embodiment, the at least one securing member includes a shaft for engaging the retaining assembly. In another embodiment, the shaft engages the clamping member. In a further embodiment, the shaft is in the form of a threaded bolt.

In one particularly preferred embodiment, the mounting element includes a mounting plate with two threaded bolts spaced apart on a planar section of the mounting plate; the clamping member includes a clamping plate having a central triangular shaped section and a flat section on either side, each flat section having an aperture to receive one of the threaded bolts; and there are two securing members each including internally threaded nuts for engaging the threaded bolts to secure the clamping plate to the mounting element.

In another particularly preferred embodiment, the mounting element includes a mounting plate; the clamping member includes a threaded bolt fixed to the mounting plate, the threaded bolt having an open slot to receive the cross member; and the securing member includes an internally threaded nut for engaging the threaded bolt to secure the cross member in the open slot.

In some embodiments, the cross member includes a flexible cable, wire or rope. In other embodiments, the cross member includes a rod or pole. In further embodiments, the cross member includes a bar, T-shaped bar or beam.

In some embodiments, the system includes a pair of cross members. In other embodiments, system includes three or more cross members. Preferably, the cross members are arranged inwardly of the ends of the at least one panel by a predetermined distance, in use. In some embodiments, the cross members are arranged inwardly of a first end of the ends of the at least one panels by a first predetermined distance. In some embodiments, the cross members are arranged inwardly of a second end of the ends of the at least one panel by a second predetermined distance. In some embodiments, the first predetermined distance is equal to the second predetermined distance. In some embodiments, the first predetermined distance is different to the second predetermined distance.

Where the cross members are connected to more than one acoustic panel, the cross members are preferably arranged inwardly of the respective ends of the associated acoustic panels by a predetermined distance, in use. In some embodiments, the cross members are arranged inwardly of a first end of the respective ends of the associated acoustic panels by a first predetermined distance. In some embodiments, the cross members are arranged inwardly of a second end of the respective ends of the associated acoustic panels by a second predetermined distance.

According to a second aspect of the present disclosure, there is provided an acoustic baffle system, including:
a plurality of acoustic panels;
a plurality of stiffening members, each stiffening member being configured for attachment to a respective panel; and
the mounting system of the first aspect of the disclosure;
wherein the connecting elements for connect the one or more cross members to the acoustic panels such that the one or more cross members extend orthogonally to the longitudinal axis of each associated panel.

In some embodiments, the connecting elements connect the one or more cross members to the stiffening member of each associated panel.

Preferably, each stiffening member is configured to be attached to a first longitudinal edge of the stiffening member. In some embodiments, the length of each stiffening member corresponds to the length of the first longitudinal edge of the associated panel.

In some embodiments, each stiffening member is elongate and a uniform cross-sectional profile along its length. Preferably, each stiffening member is extruded. In some embodiments, each stiffening member has a receiving formation for receiving at least a portion of the associated panel. In some embodiments, the cross-sectional profile of each stiffening member is generally U- or C-shaped having an open side, thereby to define the receiving formation. In some embodiments, the width of the open side of the receiving formation is the same or substantially the same as the thickness of the panels, thereby to provide for a close-fitting, a size for size or an interference fit between the stiffening member and the associated panel. In other embodiments, the thickness of the panel may be less than the width of the open side of the receiving formation, wherein one of more fasteners is used to secure the panel to the stiffening member.

In some embodiments, each panel has a constant thickness. Preferably, each panel has the same thickness. The thickness of each panel is preferably in the range of 10 to 30 mm, more preferably 12 to 25 mm.

In some embodiments, each panel is formed of a flexible material. In some embodiments, each panel has a predetermined length. In some embodiments, each panel has the same predetermined length. In certain embodiments, each panel of the plurality of acoustic panels has the same shape, dimensions and/or material properties. In further embodiments, the panels may be elongate, have leading or trailing edges that are inclined or curved and adopt different shapes, including rectangular, square, triangular, trapezoidal or any other polygonal shape.

According to a third aspect of the present disclosure, there is provided a retaining assembly for retaining a cross member to an acoustic panel, including:
a clamping member for holding the cross member so that the cross member extends orthogonally to the longitudinal axis of the acoustic panel,
wherein the clamping member is configured to locate the cross member against the acoustic panel and includes at least one aperture for receiving at least one securing member for securing the clamping member to the acoustic panel.

According to a fourth aspect of the present disclosure, there is provided a mounting system for an acoustic panel, including:
one or more cross members for supporting the acoustic panel;
a plurality of connecting elements for connecting the one or more cross members to the acoustic panel such that the one or more cross members extend orthogonally to the longitudinal axis of the acoustic panel; and
the retaining assembly of the third aspect of the present disclosure.

According to a fifth aspect of the present disclosure, there is provided an acoustic baffle system, including:
a plurality of acoustic panels;
a plurality of stiffening members, each stiffening member being configured for attachment to a respective acoustic panel; and
the mounting system of the fourth aspect of the disclosure;
wherein the connecting elements for connect the one or more cross members to the acoustic panels such that the one or more cross members extend orthogonally to the longitudinal axis of each associated panel.

### BRIEF DESCRIPTION OF THE SEVERAL VIEWS OF THE DRAWINGS

Preferred embodiments of the disclosure will now be described, by way of example only, with reference to the accompanying drawings in which:

FIG. 1 shows a schematic view of an acoustic baffle system mounted to a suspended ceiling grid system via an embodiment of a mounting system according to the disclosure incorporating a T-bar cross member;

FIG. 2 shows an enlarged exploded view of the mounting system of FIG. 1 from a first viewpoint;

FIG. 3 shows an enlarged exploded view of the mounting system of FIG. 1 from a second viewpoint;

FIG. 4 shows a side view of one element of the mounting system of FIG. 1;

FIG. 5 shows a schematic view of an acoustic baffle system mounted to a ceiling via an embodiment of a mounting system according to the disclosure incorporating a slung cable cross member;

FIG. 6 shows an enlarged exploded view of the mounting system of FIG. 5 from a first viewpoint;

FIG. 7 shows an enlarged exploded view of the mounting system of FIG. 5 from a second viewpoint;

FIG. 8 shows a side view of one element of the mounting system of FIG. 5;

FIG. 9 shows a schematic view of an acoustic baffle system employing an embodiment of a mounting system according to the disclosure incorporating a pair of vertically disposed rod cross members;

FIG. 10 shows an enlarged exploded view of the mounting system of FIG. 9 from a first viewpoint; and

FIG. 11 shows an enlarged exploded view of the mounting system of FIG. 9 from a second viewpoint.

### DETAILED DESCRIPTION

Referring to the drawings and initially to FIGS. 1 to 4, one embodiment of a mounting system 1 for an acoustic baffle system 2 is shown. The acoustic baffle system includes a plurality of acoustic panels 5 with stiffening members in the form of extruded elongate sections or beams 8 having a receiving formation with a U- or C-shaped cross-sectional profile. The beams 8 are attached to a longitudinal edge of each acoustic panel 5.

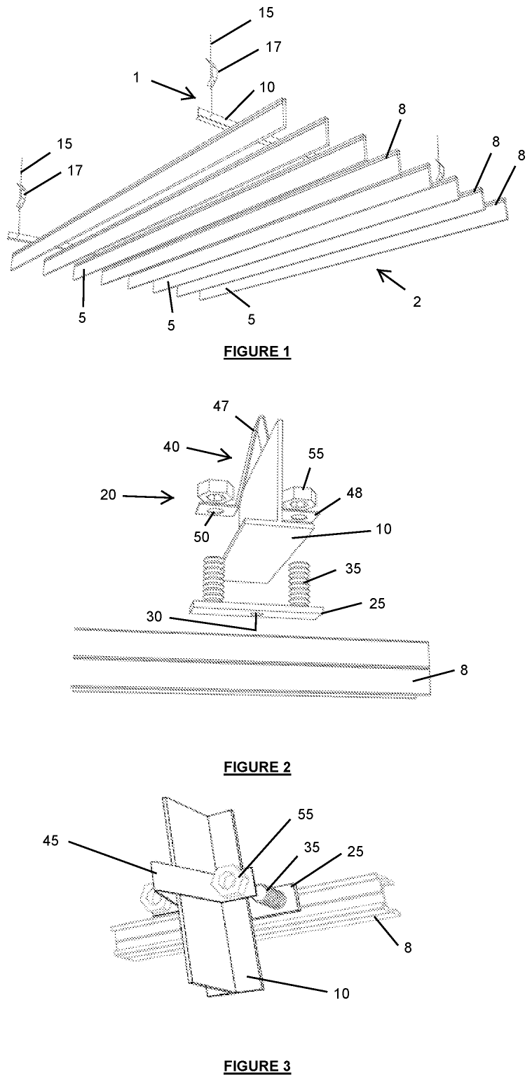

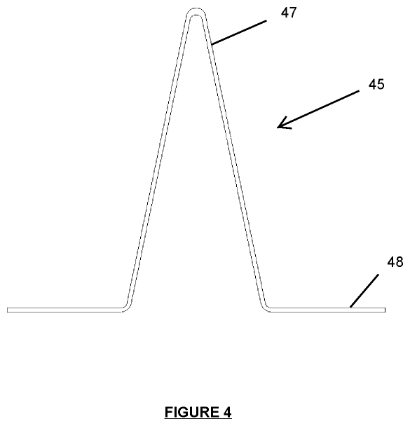

The mounting system 1 includes cross members, which in this embodiment take the form of T-shaped bars 10, as best shown in FIGS. 2 and 3. In this application of the embodiment, there are two T-shaped bars 10 that are connected to each of the acoustic panels 5. It will be appreciated that any number of cross members like the T-shaped bars 10 may be used to support the acoustic panels 5, even a single cross member, but it is preferred that there are at least two cross members to provide sufficient stability and distributing the load uniformly across the mounting system 1.

Cables 15 are connected to the T-shaped bars 10 to suspend the acoustic baffle system 2 from a ceiling (not shown). Adjustable buckles 17 are fitted to the cables 15 to vary the height of the acoustic panels 5 relative to the ceiling.

The mounting system 1 also includes connecting elements 20 for connecting the acoustic panels 5 to the T-shaped bar 10. The connecting elements each include a mounting element for connection to the acoustic panel 5 in the form of a mounting plate 25 having a central aperture 30 for receiving a fastener (not shown) to affix the mounting plate 25 to the beam 8, and thus the acoustic panel 2. The mounting plate 25 also includes threaded bolts 35 upstanding from the upper surface of the mounting plate.

The connecting elements 20 also include a retaining assembly 40 having a clamping member to hold the cross member and one or more securing members to secure the clamping member to the cross member. In this embodiment, the clamping member takes the form of a rigid clamping plate or strap 45 having a central triangular section 47 and two flat sections 48 on either side, as best shown in FIGS. 2 to 4. Openings in the form of apertures 50 are located in each flat section 48 for receiving the threaded bolts 35 of the mounting plate 25. The securing members in this embodiment are threaded nuts 55 for engaging the threaded bolts 35 to secure the clamping strap 45 to the T-shaped bar 10 and the mounting plate 25.

To assemble the acoustic system 2 using the mounting system 1, the mounting plates 25 are fixed to the beams 8 of each acoustic panel 5 and then the T-shaped bar 10 is positioned between the threaded bolts 35 of the mounting plate. The clamping strap 45 is then located on the T-shaped bar and the mounting plate 25, with the threaded bolts 35 extending through the apertures 50 of the clamping strap 45. The nuts 55 are then screwed onto the threaded bolts 35 to secure the clamping strap 45 to the mounting plate 25, thereby clamping the T-shaped bar 10 to the acoustic panel 5. This process is repeated for each acoustic panel at each end and then the T-shaped bars 10 are connected to their respective cables 15 to be drawn up toward the ceiling. The adjustable buckles 17 are then used to position the acoustic panels 5 into their final installed positions.

It can be seen that the cooperation of the connecting elements 20, which in this embodiment include the mounting plate 20, clamping member 45, and nuts 55, ensure that the T-shaped bars are orientated so as to extend in a direction orthogonal to the longitudinal axis of the acoustic panels 5, as well as their fitted beams 8. This arrangement enhances the structural integrity of the acoustic baffle system 2, as well as each individual acoustic panel 5.

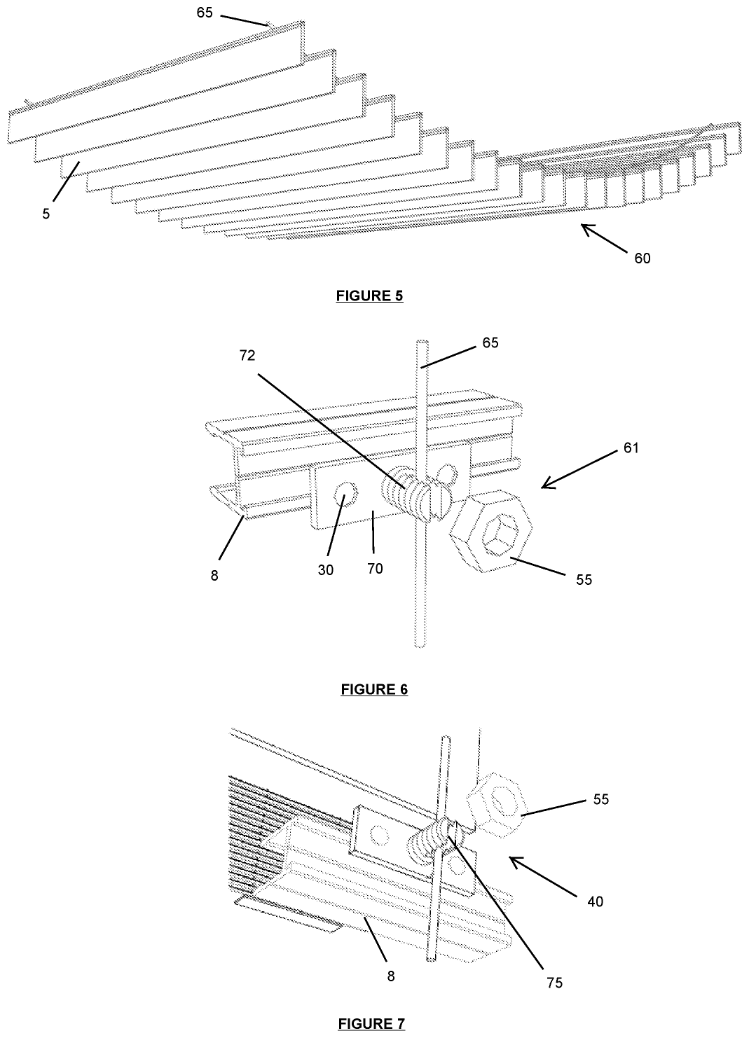

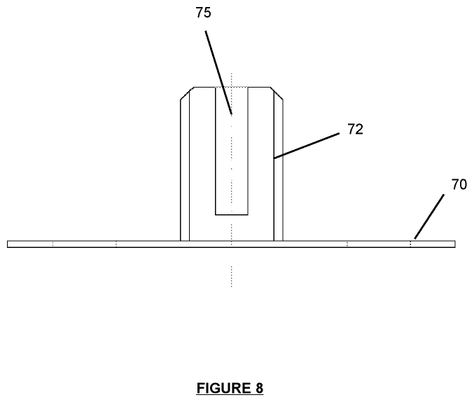

Referring to FIGS. 5 to 8, another embodiment of a mounting system 60 is shown for another embodiment of an acoustic baffle system 62, where corresponding features have been given the same reference numerals. For clarity of illustration, the acoustic panel 5 is omitted from FIGS. 6 and 7.

As with the embodiment of FIGS. 1 to 4, the acoustic baffle system 62 includes acoustic panels 5 fitted with stiffening members in the form of extruded a U- or C-shaped beams 8. However, the acoustic panels 5 are suspended in a curved plane by cross members in the form of cables 65 using the mounting system 60.

The mounting system 60 includes a planar mounting plate 70 having two openings in the form of apertures 30 for fixing the mounting plate 70 to the beam 8 using a suitable fastener (not shown). The retaining assembly 40 includes a clamping member in the form of a threaded shaft or bolt 72 fixed to the mounting plate 70 having an open slot 75 for receiving one of the cables 65, as best shown in FIGS. 6 to 8. The securing member in the form of threaded nut 55 engages the threaded shaft 72 to secure the cable 65 in the slot 75 and to the clamping member. As with the first embodiment, the open slot 75 is arranged in the threaded bolt 72 so that the cable 65 extends in a direction orthogonal to the beam 8 and hence the acoustic panel, enhancing the structural integrity of the acoustic panel 5, as well as distributing the load on the cable 65. Consequently, the structural integrity of the overall acoustic baffle system is improved with greater resilience to the load of the acoustic panels 5.

The mounting system 60 works in a substantially similar manner, as described above in relation to the mounting system 1 of FIGS. 1 to 4. The mounting plate 70 is fixed to the beam 8 by fasteners inserted through the apertures 30 into the beam. However, in this embodiment, as the threaded bolt 72 has already been fixed the to the mounting plate 70, the cable 65 is inserted into the open slot 75 and then the nut 55 is screwed onto the threaded bolt 72 until the cable 65 is tightly held between the threaded bolt 72 and nut 55.

It will be appreciated that in other embodiments, the threaded bolt 72 may be a separate component and need not be integrally formed with or welded to the mounting plate 70, but instead separately affixed to the mounting plate 70 or even to the beam 8 through an aperture provided in the mounting plate 70.

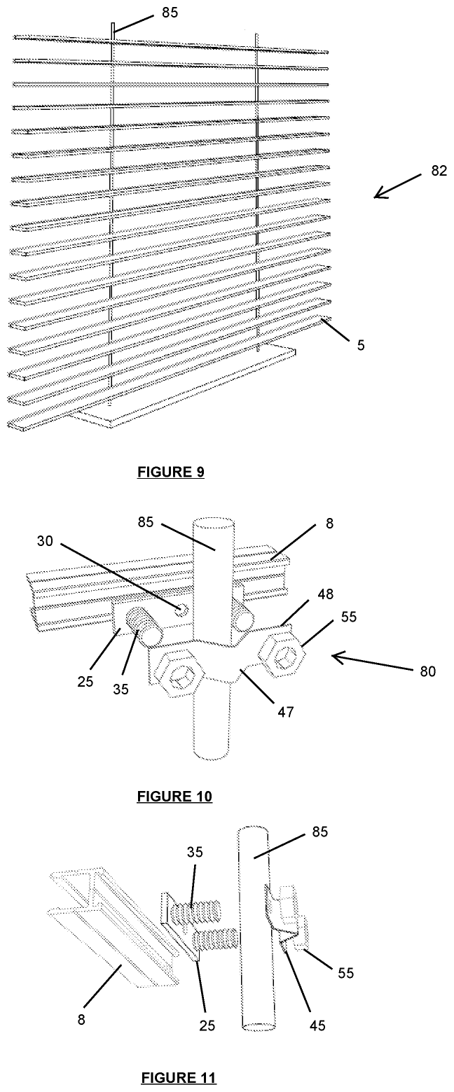

Referring to FIGS. 9 to 11, a further embodiment of a mounting system 80 is shown for another embodiment of an acoustic baffle system 82, where corresponding features have been given the same reference numerals. For clarity of illustration, the acoustic panel 5 is omitted from FIGS. 10 and 11.

As in the earlier described embodiments, the acoustic baffle system 82 includes acoustic panels 5 fitted with stiffening members in the form of extruded a U- or C-shaped beams 8. This time, the acoustic panels 5 are suspended in a substantially vertical plane by cross members in the form of cylindrical rods 85 that are connected to the ceiling (not show) using the mounting system 80.

The mounting system 80 is essentially the same as the mounting system of FIGS. 1 to 5, having a mounting plate 25 with central aperture 30 and threaded bolts 35 one either side to cooperate with a clamping plate or strap 45 and nuts 55. However, the triangular section 47 of the clamping strap 45 has a smaller angle in order to accommodate the lower profile of the rods 85. As the manner of installing the acoustic baffle system 82 using the mounting system 80 is essentially the same as for the embodiment of FIGS. 1 to 5, it will not be repeated for this embodiment.

While the clamping member in the embodiments of FIGS. 1 to 5 and 9 to 11 takes the form of a clamping plate or strap 45 having a central triangular section 47, it will be appreciated that the clamping member may take a variety of forms so long as it is configured to the clamping member is configured to engage or grip a portion of the cross member, at least partially wrap around the cross member or has a shape at least partly complementary to the shape of the cross member. For example, the central section of the clamping plate 45 may be curved or arched, adopt a U-shape, rectangular or square shaped or any other polygonal shape. In particular, where the cross member has a particular shape, such as a circular, rectangular or other polygonal cross-section, the central section have a complementary shape, such as arched, rectangular or matching polygonal shape.

Similarly, the securing members for the clamping plate 45 are not limited to the threaded bolts 35 and nuts 55 as shown in FIGS. 1 to 5 and 9 to 11, but may include other forms of fastening, such as nails or screws that inserted into the mounting plate 25, beams 8 and/or acoustic panel 5 to secure the clamping member to the acoustic panel.

It is preferred that the acoustic baffle systems 2, 62, 82 employ at least two cross members for each acoustic panel to provide sufficient stability and structural integrity to the entire system. To provide additional stability and structural integrity, one or more additional cross members can be added to the system, suitably spaced apart.

Generally, the cross members are preferably arranged inwardly of the ends of the each of the acoustic panels 5 by a predetermined distance, in use. Where at least two cross members are used, they may each be arranged inwardly of the respective ends of each of the acoustic panels 5 by the same predetermined distance. In some applications, the cross members may be arranged inwardly of the respective ends of each of the acoustic panels 5 by different predetermined distances.

While the embodiments have been described as using cross members in the form of T-shaped bars, cables and cylindrical rods, persons skilled in the art will recognize that other types of cross members may be used. For example, the cables may be substituted with other types of thin flexible members, such as wires or ropes. Similarly, the rods could be replaced with poles and the T-shaped bars could be replaced with beams or other shaped bars. In each case, the clamping member would need only have a shape that permits holding the cross member in place to orient the cross bar so that it extends in a direction orthogonal to the longitudinal axis of the acoustic panels 5. Moreover, the various cross members may have different cross-sectional profiles like square, rectangular, oval, hexagonal and other polygonal shapes other than the described circular cross-sections of the cables and cylindrical rods.

In the embodiments, the stiffening member in the form of the beam 8 has a length corresponding to the length of the longitudinal edge of the associated acoustic panel. The stiffening member is also elongate, has a uniform cross-sectional profile along its length and is preferably formed by extrusion. The configuration of the stiffening member may vary from these parameters as desired. Similarly, while the receiving formation of each stiffening member is defined by the open side of the generally U- or C-shaped cross-sectional profile, it will be appreciated that other types of cross-sectional profile defining the different receiving formations may be used.

Moreover, in the embodiments, the width of the open side of the receiving formation is the same or substantially the same as the thickness of the panels, thereby to provide for a close-fitting, a size for size or an interference fit between the stiffening member and the associated acoustic panel. In other embodiments, the thickness of the panel may be less than the width of the open side of the receiving formation, wherein one of more fasteners is used to secure the panel to the stiffening member.

In the embodiments, each acoustic panel 5 has a constant thickness to provide a uniform acoustic dampening effect, and generally it is preferred that each acoustic panel 5 has the same thickness, but this may vary to meet installation or operational requirements. The thickness of each acoustic panel may range from 10 to 30 mm, and preferably 12 to 25 mm.

Generally, the acoustic panels 5 are composed of a flexible material with a predetermined length. Also, the lengths of the acoustic panels 5 may be the same, but can vary to fit within the parameters of a room or space in which the acoustic baffle system is installed. This variation in the acoustic panels 5 to meet operational requirements may extend to other characteristics of the acoustic panels, such as shape, dimensions and/or material properties. For example, some or all of the acoustic panels 5 may have leading or trailing edges that are inclined or curved, as well as adopting different shapes, including rectangular, square, triangular, trapezoidal or any other polygonal shape.

The use of the mounting system of the disclosure enables the acoustic baffle system to be arranged in a wider variety of configurations, such as vertical, horizontal, and angular suspension. In addition, the mounting system permits a selection of relatively simple and quick to install mechanisms, as well as providing a range of options for site orientation; either vertically, horizontally, or diagonally, attached to room structures or mounted to free-standing supports, parallel, perpendicular, radiating from shared center points, or slung from cables. This provides added versatility to the acoustic baffle system in terms of being able to install the acoustic baffles in many different orientations via the different mounting options offered by the mounting system of the disclosure. In all these respects, the disclosure represents a practical and commercially significant improvement over the prior art.

Although the disclosure has been described with reference to specific examples it will be appreciated by those skilled in the art that the disclosure may be embodied in many other forms.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A retaining assembly for retaining a cross member to an acoustic panel, including:
a clamping member for holding the cross member so that the cross member extends orthogonally to a longitudinal axis of the acoustic panel,
wherein the clamping member is configured to locate the cross member against the acoustic panel and includes at least one aperture for receiving at least one securing member for securing the clamping member to the acoustic panel.

2. The mounting system of claim 1, wherein the clamping member is configured to engage or grip a portion of the cross member, at least partially wrap around the cross member or has a shape at least partly complementary to the shape of the cross member.

3. The retaining assembly of claim 1, wherein the clamping member includes a clamping plate having a central section configured to engage or grip a portion of the cross member, at least partially wrap around the cross member or has a shape at least partly complementary to the shape of the cross member.

4. The retaining assembly of claim 3, wherein the central section has a U-shape, arched shape, rectangular shape or triangular shape.

5. The retaining assembly of claim 3, wherein the clamping plate includes a flat section on either side of the central section, each flat section having the at least one aperture to receive the at least one securing member.

6. The mounting system of claim 1, wherein the clamping member includes an opening to receive the cross member.

7. The retaining assembly of claim 11, wherein the at least one securing member includes a shaft configured to engage a respective fastener.

8. The retaining assembly of claim 1, wherein the at least one securing member includes two threaded bolts and two internally threaded nuts for engaging the two threaded bolts, respectively; the clamping member including a clamping plate having a central triangular shaped section and a flat section on either side, each flat section having an aperture to receive one of the two threaded bolts; and wherein the internally threaded nuts engage the two threaded bolts to secure the clamping plate to the acoustic panel.

9. A mounting system for an acoustic panel, including:
one or more cross members for supporting the acoustic panel;
a plurality of connecting elements for connecting the one or more cross members to the acoustic panel such that the one or more cross members extend orthogonally to the longitudinal axis of the acoustic panel; and
the retaining assembly of claim 1.

10. The mounting system of claim 9, wherein the connecting elements include a mounting element for engaging the panel and the retaining assembly retains the cross member to the connecting element.

11. The mounting system of claim 9, wherein the mounting element includes one or more apertures for receiving a fastener to connect the mounting element to the acoustic panel.

12. The mounting system of claim 9, wherein the clamping member holds the cross member against the mounting element.

13. The mounting system of claim 9, wherein the opening of the clamping member is arranged to be orthogonal to the longitudinal axis of the acoustic panel when the connecting elements are connected to the acoustic panel.

14. The mounting system of claim 9, wherein the cross member includes a flexible cable, wire, rope, rod, pole, a bar, T-shaped bar or beam.

15. The mounting system of claim 9, wherein there are two or more cross members arranged inwardly of the respective ends of the at least one panel by a predetermined distance, in use.

16. An acoustic baffle system, including:
a plurality of acoustic panels;
a plurality of stiffening members, each stiffening member being configured for attachment to a respective acoustic panel; and
the mounting system of any one of the preceding claim,;
wherein the connecting elements connect the cross members to the acoustic panels such that the cross members extend orthogonally to the longitudinal axis of each associated acoustic panel.

17. The acoustic baffle system of claim 16, wherein the connecting elements connect the cross members to the stiffening member of each associated panel.

18. The acoustic baffle system of claim 16, wherein each stiffening member is configured to be attached to a first longitudinal edge of the stiffening member.

19. The acoustic baffle system of claim 18, wherein each stiffening member has a receiving formation for receiving at least a portion of the associated panel.

20. The acoustic baffle system of claim 19, wherein the width of the open side of the receiving formation is the same or substantially the same as the thickness of the panels, thereby to provide for a close-fitting, a size for size or an interference fit between the stiffening member and the associated panel.
